(19) United States
(12) Patent Application Publication
(10) Pub. No.: US 2024/0184073 A1
(43) Pub. Date: Jun. 6, 2024

(54) Patch Panel

(71) Applicant: Panduit Communication Components (Wuxi) Co., Ltd., Wuxi, Jiangsu (CN)

(72) Inventor: Ke Liu, Wuxi, Jiangsu (CN)

(73) Assignee: Panduit Communication Components (Wuxi) Co., Ltd., Wuxi, Jiangsu (CN)

(21) Appl. No.: 18/285,537

(22) PCT Filed: Apr. 2, 2022
(86) PCT No.: PCT/CN2022/084972

§ 371 Date: Oct. 4, 2023

(30) Foreign Application Priority Data
Apr. 7, 2021 (CN) 202120711555.2

(51) Int. Cl. G02B 6/44

(52) U.S. Cl. CPC G02B 6/4452; G02B 6/44785

(57) ABSTRACT

A patch panel includes: a patch panel body, each end of which is provided respectively with a first rotation connect; two patch clamps, mounted respectively on each end of the patch panel body; and a cover panel, each end of which is provided respectively with a second rotation connect, and the second rotation connect is capable of being rotatably engaged with the first rotation connect. The patch panel is specifically an optical fiber patch panel. The patch panel with such a structure facilitates operation on the cables.

### FIELD

The utility model belongs to a field of electrical apparatus, specifically relates to a structural improvement of a patch panel used for cables such as electrical wires, signal wires and the like, especially relates to an optical fiber patch panel.

### BACKGROUND

Patch panel (also referred as “cable manager”) is broadly used in apparatuses such as electrical cabinet, data center and the like, for managing cables therein, such as electrical wires, signal wires and the like. The patch panel is mounted on an apparatus mounting bracket of the electrical cabinet, for supporting cables in the apparatus and facilitating cable management between apparatuses. Optical fiber patch panel is a patch panel dedicated for managing wiring of optical fibers.

During use, it is found that some kind of patch panels have problems such as limited spaces, hard working in wiring, thus resulting low efficiency of mounting in site.

Therefore, there is need for a patch panel with improved structure, thus solving the technical problems mentioned above in the existing patch panel.

### SUMMARY

The present utility model is made for overcoming the existing problems in the prior art mentioned above. One object of the present utility model is to provide a patch panel, especially an optical fiber patch panel, with improved structure, which can provide greater operation spaces for mounting, wiring and the like, thus facilitating in operation. And, the patch panel has a simple structure, and can reduce manufacturing cost.

A patch panel of the present utility model includes:
a patch panel body, each end of which is provided respectively with a first rotation connect;
two patch clamps, mounted respectively on each end of the patch panel body; and
a cover panel, each end of which is provided respectively with a second rotation connect, and the second rotation connect is capable of being rotatably engaged with the first rotation connect.

In such a patch panel with the above mentioned structure, the cover panel may rotate with respect to the patch panel body, thus may possess an open position and a closed position, which may facilitate in handling cables in the patch panel. And, the patch panel has a simple structure, and also may reduce manufacturing cost.

In a preferred structure, one of the first rotation connect and the second rotation connect is a hinge, and the other one of the first rotation connect and the second rotation connect is a pin hole. Such a rotatable connecting structure allows the cover panel to rotate in a range of at least 180 degrees.

In a preferred specific structure, the patch panel body includes:
a front panel, on which at least one adaptor mounting hole is provided, for example three adaptor mounting holes may be included; and
a bottom plate, on which at least one bottom operation hole is provided, for example four bottom operation holes may be provided. Further, each end of the bottom plate is provided with the above mentioned second rotation connect.

The adaptor mounting hole may be used for mounting an adaptor of the cable, the provision of the bottom operation hole provides operators with added operation spaces, thus further facilitating in mounting and managing the cables.

Preferably, each end of the bottom plate is respectively provided with a mounting hole and/or a boss in a bended shape. The mounting hole is used for mounting the optical fiber patch panel to the apparatus mounting bracket of the cabinet, and the boss may increase strength of the bottom plate, thus increasing capability of supporting the optical fiber patch panel.

Preferably, a push-pull locking button is provided on the cover plate, and a locking hole is provided at a corresponding position on the patch panel body, the push-pull locking button is capable of being detachably engaged with the locking hole. The push-pull locking button may facilitate in operation by the operators, so that the cover plate shifts between the open position and the closed position. And, engagement between the push-pull locking button and the locking hole may lock the cover plate in the closed position.

Preferably, the patch clamp is made of plastic. The patch panel body is integrally formed by a cold rolling steel plate, for example a cold rolling steel plate with 1.5 mm thickness. The cover plate may also be made of a cold rolling steel plate, for example a cold rolling steel plate with 1 mm thickness.

Preferably, one example of the patch panel is an optical fiber patch panel, and correspondingly the patch clamp is specifically an optical fiber patch clamp.

### BRIEF DESCRIPTION OF DRAWINGS

Embodiments of the present utility model can be understood better from the structure shown in the attached drawings, in the drawings:

FIG. 1 is an exploded perspective view of an optical fiber patch panel of the present utility model.

FIG. 2 is a perspective view of the optical fiber patch panel of the present utility model in an assembled state.

### LIST OF THE REFERENCE NUMBERS

1 optical fiber patch panel
10 patch panel body
11 front panel
12 adaptor mounting hole
13 bottom plate
14 bottom operating hole
15 boss
16 locking hole
17 pin hole
20 optical fiber patch clamp
30 cover plate
31 hinge
32 push-pull locking button

### DETAILED DESCRIPTION

In order to facilitate in understanding the present utility model, embodiments of the apparatus of the present utility model will be described by reference to the drawings. It shall be understood that the drawings only show the preferred embodiments of the present utility model, and it shall not be understood as a limitation on the scope of the present utility model. One skilled in the art can obtain any obvious modifications, variations, equivalents based on the embodiments shown in the drawings, and in case of not conflicting with each other, the features in different embodiments described can be combined with each other at will, and all of these combinations fall in the scope of the present utility model.

Preferred structure of the present utility model will be disclosed in detail hereinafter in the context of an optical fiber patch panel 1 used for optical fibers.

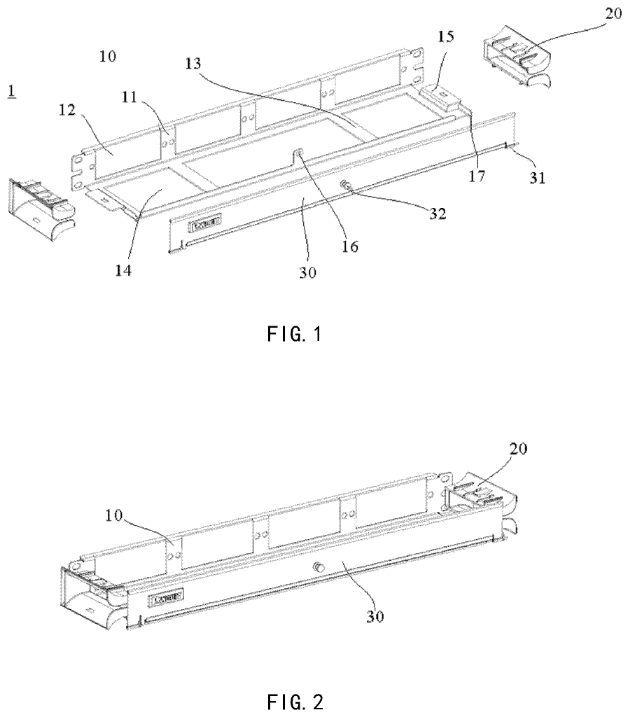

FIG. 1 shows an exploded perspective view of an optical fiber patch panel 1 of the present utility model, where components of the optical fiber patch panel 1 are clearly shown.

The optical fiber patch panel 1 includes a patch panel body 10, each end of which is provided respectively with an optical fiber patch clamp 20, optical fibers extends through the optical fiber patch clamp 20 into the optical fiber patch panel 1, and are clamped by the optical fiber patch clamp 20. The optical fiber clamp 20 is made preferably of plastic.

The patch panel body 10 includes a front panel 11 and a bottom plate 13 At least one adaptor mounting hole 12 is provided on the front panel 11, an optical fiber adaptor (not shown) may be mounted to the optical fiber patch panel 1 via the adaptor mounting hole 12. In the preferred structure shown in the drawings, four adaptor mounting holes 12 are provided on the front panel 11. The bottom plate 13 is provided with at least one bottom operation hole (three bottom operation holes in the structure shown in the drawings) 14. The bottom operation hole 14 provides operators with more operation spaces. The operators can approach the optical fibers and fiber adaptors in the optical fiber patch panel 1 through the bottom operation hole 14. Thus, the provision of the bottom operation hole 14 facilitates the operators in mounting and demounting the optical fibers.

Each end of the bottom plate 13 of the patch panel body 10 can be provided respectively with mounting holes for mounting the optical fiber patch panel 1 into the cabinet, for example the mounting holes is provided so that it is adapted to mount the optical fiber patch panel 1 in a standard cabinet of 19 inches.

In addition, preferably, each end of the bottom plate 13 of the patch panel body 10 can be provided respectively with a boss 15 in a structure bended with respect to the bottom plate 13. With the provision of the boss 15, strength of the bottom plate 13 can be improved, and thus improving the whole strength of the optical fiber patch panel 1. The optical fiber patch clamp 20 is mounted at the position of the boss 15, and the improved strength of the boss 15 can help in supporting the optical fiber patch clamp 20.

Preferably, the patch panel body 10 is integrally made of a cold rolling steel plate. And more preferably, the cold rolling steel plate is a steel plate of 1.5 mm thickness.

A cover plate 30 is provided at a side facing the front panel 11 of the patch panel body 10. The cover plate 30 is preferably also formed of a cold rolling steel plate, for example a cold rolling steel plate of 1 mm thickness.

Each side of the bottom of the cover plate 30 is provided respectively with a hinge 31, which is rotatably engaged with a pin hole 17 provided on the patch panel 10. Specifically, each end of the bottom plate 13 of the patch panel body 10 is provided with the pin hole 17. By means of engagement between the hinge 31 and the pin hole 17, the cover plate 30 is allowed to rotate with respect to the bottom plate 13 of the patch panel body 10 in a range of at least 180 degrees, so that the cover plate 30 is able to shift between an open position and a closed position.

Here, the position where the hinge 31 and the pin hole 17 are provided may be interchanged, i.e. a hinge can be provided on the patch panel body 10 and a pin hole can be provided on the cover plate 30.

A push-pull locking button 32 is further provided on the cover plate 30, and the operators may rotate the cover plate 30 by means of the push-pull locking button 32. And, a locking hole 16 is further provided on the bottom plate 13 of the patch panel body 10, at a position corresponding to the push-pull locking button 32 of the cover plate 30, and the push-pull locking button 32 can be detachably engaged with the locking hole 16. When the cover plate 30 is in the closed position, the push-pull locking button 32 can engage into the locking hole 16, so that the cover plate 30 is locked in the closed position.

Preferably, the patch panel body 10 and the cover plate 30 can undergo a static electrical coating process, for example the patch panel body 10 and the cover plate 30 are coated into black. Optionally, a surface, facing inwardly, of the cover plate 30 can be attached by a label, which can help in managing the optical fiber.

For the optical fiber patch panel 1 with the structure shown in the drawings, the optical fiber patch clamp 20 is mounted at each end of the bottom plate 13 of the patch panel body 10, for example at the position of the boss 15. The hinge 31 of the cover plate 30 engages with the pin hole 17 on the bottom plate 13, so that the cover plate 30 is mounted on the patch panel body 10, and the cover plate 30 can rotate to the closed position. Thereby, an assembled optical fiber patch panel 1 as shown in FIG. 2 is obtained.

1. A patch panel, characterized in that the patch panel includes:
a patch panel body, each end of which is provided respectively with a first rotation connect;
two patch clamps, mounted respectively on each end of the patch panel body; and
a cover panel, each end of which is provided respectively with a second rotation connect, and the second rotation connect is capable of being rotatably engaged with the first rotation connect.

2. The patch panel according to claim 1, characterized in that one of the first rotation connect and the second rotation connect is a hinge, and the other of the first rotation connect and the second rotation connect is a pin hole.

3. The patch panel according to claim 1, characterized in that the patch panel body includes:
a front panel, on which at least one adaptor mounting hole is provided; and
a bottom plate, on which at least one bottom operation hole is provided, and each end of the bottom plate is provided with the second rotation connect.

4. The patch panel according to claim 3, characterized in that each end of the bottom plate is provided respectively with a mounting hole and/or a boss in a bended shape.

5. The patch panel according to claim 1, characterized in that a push-pull locking button is provided on the cover plate, and a locking hole is provided at a corresponding position on the patch panel body, the push-pull locking button is capable of being detachably engaged with the locking hole.

6. The patch panel according to claim 1, characterized in that the patch clamps are made of plastic; and/or
the patch panel body is integrally formed of a cold rolling steel plate; and/or
the cover plate is formed of a cold rolling steel plate.

7. The patch panel according to any one of claims 1-6, characterized in that the patch panel is an optical fiber patch panel, and the patch clamp is an optical fiber patch clamp.
